(19) United States
(12) Patent Application Publication
(10) Pub. No.: US 2019/0031859 A1
(43) Pub. Date: Jan. 31, 2019

(54) RESIN COMPOSITION AND RESIN MOLDED ARTICLE

(71) Applicant: FUJI XEROX CO., LTD., Tokyo (JP)

(72) Inventor: Kana MIYAZAKI, Kanagawa (JP)

(73) Assignee: FUJI XEROX CO., LTD., Tokyo (JP)

(21) Appl. No.: 15/928,100

(22) Filed: Mar. 22, 2018

(30) Foreign Application Priority Data
Jul. 27, 2017 (JP) 2017-145880

(51) Int. Cl. C08L 1/12

(52) U.S. Cl. CPC C08L 1/12

(57) ABSTRACT

A resin composition includes a cellulose acylate (A) and a polyether derivative (B) having at least one carbon-carbon unsaturated bond excluding an aromatic group in a molecule.

### CROSS-REFERENCE TO RELATED APPLICATIONS

This application is based on and claims priority under 35 USC 119 from Japanese Patent Application No. 2017-145880 filed Jul. 27, 2017.

### BACKGROUND

### (i) Technical Field

The present invention relates to a resin composition and a resin molded article.

### (ii) Related Art

Various resin compositions have been provided and used for many purposes. Particularly, resin compositions are used for various components, housings, or the like of home appliances or vehicles. In addition, thermoplastic resins are also used for components such as housings of office equipment or electronic or electric equipment.

In recent years, plant-derived resins have been used, and a cellulose derivative is a plant-derived resin which has been known.

### SUMMARY

According to an aspect of the invention, there is provided a resin composition including a cellulose acylate (A) and a polyether derivative (B) having at least one carbon-carbon unsaturated bond excluding an aromatic group in a molecule.

### DETAILED DESCRIPTION

Hereinafter, a resin composition and a resin molded article according to an exemplary embodiment of the invention will be described.

In this specification, regarding the amount of a component in a resin composition, in a case where the component in the resin composition corresponds to plural kinds of substances, the amount of the component means a total amount of the plural kinds of substances existing in the resin composition unless otherwise noted.

Resin Composition

A resin composition according to the exemplary embodiment includes a cellulose acylate (A) and a polyether derivative (B) having at least one carbon-carbon unsaturated bond (excluding an aromatic group) in the molecule.

In this embodiment, the “carbon-carbon unsaturated bond” means a carbon-carbon double bond or a carbon-carbon triple bond, and has a concept excluding an aromatic group. That is, the polyether derivative (B) is a derivative having at least one carbon-carbon unsaturated bond selected from carbon-carbon double bonds and carbon-carbon triple bonds.

Cellulose has a high bending elastic modulus from a high intermolecular hydrogen bonding strength in its molecules. In addition, cellulose may be applied in areas in which resin materials of the related art are hardly applied, so that it may be a substitute for metals or the like.

However, since cellulose is poor in thermoplasticity and solubility in an organic solvent in an unmodified cellulose state due to a rigid chemical structure thereof, cellulose cannot be easily used as it is for molding such as injection molding and cast molding.

Accordingly, technologies for providing a cellulose acylate (acylated cellulose derivative) by substituting a part of cellulose hydroxyl groups with an acyl group, and for then imparting moldability by adding a plasticizer have been known.

However, a cellulose acylate has a high melt viscosity. Accordingly, in a case where the plasticizer is added until such a melt viscosity is obtained that the cellulose acylate becomes moldable, the fluidity is improved during the molding, but the mechanical strength of a resin molded article to be obtained is likely to fall. In addition, according to the storage situation, components contained may migrate and precipitate (hereinafter, may be referred to as “bleed”) to a surface of a resin molded article to be obtained.

The resin composition according to the exemplary embodiment includes a cellulose acylate (A) and a polyether derivative (B) having at least one carbon-carbon unsaturated bond in the molecule (hereinafter, may be simply referred to as “polyether derivative (B)”).

Accordingly, the resin composition has improved fluidity, compared to a resin composition only including a cellulose acylate and a polyethylene glycol not having at least one carbon-carbon unsaturated bond in the molecule, or a resin composition only including a cellulose acylate and a polyether ester not having at least one carbon-carbon unsaturated bond in the molecule. In addition, a resin molded article in which bleeding is suppressed is easily obtained.

The reason for this is not clear, but thought to be as follows.

The polyether derivative (B) has a carbon-carbon unsaturated bond and an ether group (oxygen atom of a polyether part). It is thought that in the resin composition according to the exemplary embodiment, at least one of the carbon-carbon unsaturated bond or the oxygen atom of the polyether part interacts with the polar group (for example, carbonyl group or hydroxy group) of the cellulose acylate and enters between the cellulose acylate (molecules). Accordingly, it is thought that the space between the molecules is widened and pseudo-crosslinking (a state in which the molecules attract each other by an electrical attraction force or the like, not by chemical bonding) is partially formed between the molecules. As a result, it is thought that the action of hydrogen bonding which may occur between the molecules lessens, plasticization is promoted, and the melt viscosity is likely to fall.

Accordingly, according to the resin composition according to the exemplary embodiment, the fluidity is improved.

In addition, it is thought that in the resin composition according to the exemplary embodiment, the polyether derivative (B) is hardly released from a resin molded article to be obtained due to the formation of the pseudo-crosslinking. Accordingly, a resin molded article in which bleeding is suppressed is easily obtained.

In addition, in the resin composition according to the exemplary embodiment, plasticization is promoted, and thus moldability is likely to be improved with fluidity. Accordingly, a resin molded article to be obtained easily ensures a mechanical strength (for example, at least one of tensile strength, tensile elongation, or Charpy impact strength, the same hereinbelow).

Moreover, in the resin composition according to the exemplary embodiment, since the molding temperature can be relatively lowered due to the improvement in fluidity, coloring of a resin molded article to be obtained is likely to be suppressed.

Hereinafter, the resin composition according to the exemplary embodiment will be described in detail.

Cellulose Acylate (A)

The resin composition according to the exemplary embodiment contains a cellulose acylate (A).

Structure

The cellulose acylate (A) is a cellulose derivative in which at least a part of hydroxyl groups of cellulose is substituted (acylated) with acyl groups. Specifically, the cellulose acylate is represented by, for example, Formula (1).

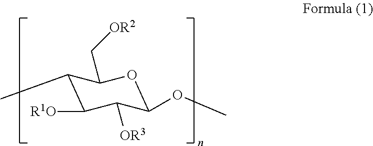

In Formula (1), R¹, R², and R³ each independently represent a hydrogen atom or an acyl group. n represents an integer of 2 or more. At least a part of n R¹, n R², and n R³ represents an acyl group.

In Formula (1), the range of n is not particularly limited. n is, for example, preferably 250 or greater and 750 or less, and more preferably 350 or greater and 600 or less.

In a case where n is 250 or greater, the mechanical strength of a resin molded article is likely to increase. In a case where n is 750 or less, a reduction in flexibility of a resin molded article is likely to be suppressed.

The acyl group represented by R¹, R², or R³ is, for example, preferably an acyl group having 1 to 6 carbon atoms, more preferably an acyl group having 1 to 4 carbon atoms, and even more preferably an acyl group having 1 to 3 carbon atoms.

n R¹'s, n R²'s, and n R³'s may be all the same, partially the same, or different from each other.

The acyl group is represented by a structure of “—CO—R_{AC}”. R_{AC} represents a hydrogen atom or a hydrocarbon group (for example, preferably a hydrocarbon group having 1 to 5 carbon atoms).

The hydrocarbon group represented by R_{AC} may be linear, branched, or cyclic, and is, for example, preferably linear.

The hydrocarbon group may be a saturated hydrocarbon group or an unsaturated hydrocarbon group, and is, for example, preferably a saturated hydrocarbon group.

The hydrocarbon group may have an atom (for example, oxygen or nitrogen) other than a carbon atom and a hydrogen atom, and is, for example, preferably a hydrocarbon group including carbon and hydrogen only.

Examples of the acyl group include a formyl group, an acetyl group, a propionyl group, a butyryl group (butanoyl group), a propenoyl group, and a hexanoyl group.

Among these, the acyl group is, for example, preferably an acyl group having 2 to 4 carbon atoms, more preferably an acyl group having 2 or 3 carbon atoms, and particularly preferably an acyl group having 2 carbon atoms (acetyl group) from the viewpoint of an improvement in fluidity of the resin composition and an improvement in mechanical strength of a resin molded article. That is, it is preferable that the cellulose acylate (A) has, for example, an acetyl group.

Substitution Degree

The substitution degree of the cellulose acylate (A) is, for example, preferably 2.0 or greater and 2.9 or less, more preferably 2.1 or greater and 2.6 or less, and even more preferably 2.2 or greater and 2.5 or less.

In a case where the substitution degree is 2.0 or greater, affinity with the polyether derivative (B) is likely to increase.

In a case where the substitution degree is 2.9 or less, crystallization of the cellulose acylate (A) is likely to be suppressed. Accordingly, in a case where the substitution degree is within the above range, the fluidity is likely to be improved.

Here, the substitution degree is an index indicating the acylation degree of the cellulose acylate. Specifically, the substitution degree means an average number of substitutions in the molecule, in which three hydroxyl groups on the D-glucopyranose unit of the cellulose are substituted with acyl groups.

The substitution degree is measured from the integration ratio of the peak derived from the acyl group and the hydrogen derived from the cellulose with the use of H¹—NMR (JMN-ECA/manufactured by JEOL RESONANCE Inc.).

Weight Average Molecular Weight (Mw)

The weight average molecular weight (Mw) of the cellulose acylate (A) is, for example, preferably 50,000 or greater and 500,000 or less, more preferably 50,000 or greater and 300,000 or less, and even more preferably 50,000 or greater and 250,000 or less from the viewpoint of an improvement in mechanical strength of a resin molded article.

Here, the weight average molecular weight (Mw) is a value measured by a gel permeation chromatograph (GPC). Specifically, the measurement of the molecular weight by a GPC is performed using HPLC1100 manufactured by TOSOH CORPORATION as a measurement device with columns TSKgel GMHHR-M and TSKgel GMHHR-M (7.8 mm, I.D. 30 cm) manufactured by TOSOH CORPORATION in a chloroform solvent. The weight average molecular weight (Mw) is calculated from the measurement result by using a molecular weight calibration curve which has been obtained by a monodisperse polystyrene standard sample.

Ratio in Entire Resin Composition

In the resin composition according to the exemplary embodiment, the ratio of the cellulose acylate (A) to the entire resin composition is, for example, preferably 50 mass % or greater and 99 mass % or less, more preferably 60 mass % or greater and 95 mass % or less, and even more preferably 70 mass % or greater and 90 mass % or less.

Producing Method

The method of producing the cellulose acylate (A) is not particularly limited. For example, the cellulose acylate may be produced by performing acylation, molecular weight reduction (depolymerization), and if necessary, deacylation on cellulose. A commercially available cellulose acylate may be used, or subjected to molecular weight reduction (depolymerization) or the like to obtain the above weight average molecular weight.

Examples of commercially available products as specific examples of the cellulose acylate (A) are as follows, but not limited thereto. Specific examples of the cellulose acylate (A) include materials having a substitution degree adjusted to 2.0 or greater and 2.9 or less by modifying the following cellulose acylate.

Cellulose Diacetate (manufactured by DAICEL CORPORATION, product name: L-50, each of substituents R¹, R², R³ represents a hydrogen atom or an acetyl group)

Cellulose Diacetate (manufactured by DAICEL CORPORATION, product name: L-20, each of substituents R¹, R², R³ represents a hydrogen atom or an acetyl group)

Cellulose Triacetate (manufactured by DAICEL CORPORATION, product name: LT-55, each of substituents R¹, R², R³ represents a hydrogen atom or an acetyl group)

Cellulose Acetate Propionate (manufactured by EASTMAN CHEMICAL COMPANY, product name: CAP482-20, each of substituents R¹, R², R³ represents a hydrogen atom, an acetyl group, or a propionyl group)

Cellulose Acetate Butyrate (manufactured by EASTMAN CHEMICAL COMPANY, product name: CAB381-0.1, each of substituents R¹, R², R³ represents a hydrogen atom, an acetyl group, or a butyryl group)

Cellulose Acetate (manufactured by EASTMAN CHEMICAL COMPANY, product name: CA398-3, each of substituents R¹, R², R³ represents a hydrogen atom or an acetyl group)

Polyether Derivative (B)

The resin composition according to the exemplary embodiment contains a polyether derivative (B) having at least one carbon-carbon unsaturated bond in the molecule.

The carbon-carbon unsaturated bond is, for example, although not particularly limited, preferably a carbon-carbon double bond.

The number of carbon-carbon unsaturated bonds in the molecule is, for example, preferably 1 or greater and 10 or less, more preferably 1 or greater and 5 or less, and even more preferably 1 or greater and 3 or less.

Examples of the aspect in which the polyether derivative (B) has a carbon-carbon unsaturated bond include an aspect in which a main chain terminal part (one terminal or both terminals) of a molecular chain has a carbon-carbon unsaturated bond; an aspect in which a main chain non-terminal part of a molecular chain has a carbon-carbon unsaturated bond (for example, an aspect in which a carbon-carbon unsaturated bond is in a main chain of a molecular chain and an aspect in which a side chain has a carbon-carbon unsaturated bond with respect to a main chain of a molecular chain); and an aspect in which both a main chain terminal part of a molecular chain and a main chain non-terminal part of the molecular chain have a carbon-carbon unsaturated bond.

From the viewpoint of an improvement in fluidity of the resin composition, for example, an aspect in which a main chain terminal part (one terminal or both terminals) of a molecular chain has a carbon-carbon unsaturated bond is preferable, and an aspect in which one terminal part of a main chain of a molecular chain has a carbon-carbon unsaturated bond is more preferable.

Structure

The polyether derivative (B) is, for example, preferably a compound represented by Formula (X).

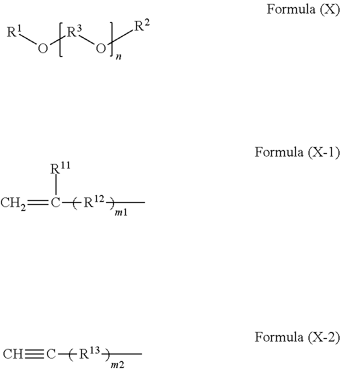

In Formula (X), R¹ represents a group represented by Formula (X-1) or a group represented by Formula (X-2). R² represents a group represented by Formula (X-1), a group represented by Formula (X-2), a hydrogen atom, an alkyl group having 1 to 10 carbon atoms, a phenyl group, or a benzyl group. R³ represents an alkylene group having 1 to 5 carbon atoms. n represents an integer of 1 to 50.

In Formula (X-1), R¹¹ represents a hydrogen atom or a methyl group. R¹² represents —CH₂— or —CO—. m1 represents 0 or 1.

In Formula (X-2), R¹³ represents —CH₂— or —CO—. m2 represents 0 or 1.

In Formula (X), the alkyl group having 1 to 10 carbon atoms represented by R² is, for example, more preferably an alkyl group having 1 to 6 carbon atoms, even more preferably an alkyl group having 1 to 3 carbon atoms, and particularly preferably a methyl group.

Examples of the alkyl group include a methyl group, an ethyl group, a propyl group, a butyl group, a pentyl group, a hexyl group, a heptyl group, an octyl group, a nonyl group, and a decyl group. The alkyl group may be linear, branched, or cyclic, and is, for example, preferably linear or branched.

In Formula (X), the alkyl group having 1 to 10 carbon atoms represented by R² may be unsubstituted or substituted with a halogen atom (for example, a fluorine atom or a chlorine atom) or the like.

In Formula (X), in a case where n is 2 or more, plural R³'s may be the same groups or different groups.

In Formula (X), the alkylene group having 1 to 5 carbon atoms represented by R³ is, for example, more preferably an alkylene group having 2 to 4 carbon atoms, and even more preferably an alkylene group having 2 or 3 carbon atoms.

Examples of the alkylene group include a methylene group, an ethylene group, a propylene group, a butylene group, and a pentylene group. The alkylene group may be linear, branched, or cyclic, and is, for example, preferably linear or branched, and more preferably branched.

In Formula (X), the alkylene group having 1 to 5 carbon atoms represented by R³ may be unsubstituted or substituted with a halogen atom (for example, a fluorine atom or a chlorine atom) or the like.

In Formula (X), n is an integer of 1 to 50. n is, for example, preferably 1 or more and 30 or less, more preferably 2 or more and 20 or less, and particularly preferably 3 or more and 10 or less.

In a case where n is 1 or more, the polyether derivative (B) hardly bleeds from a resin molded article.

In a case where n is 50 or less, affinity with the cellulose acylate (A) is likely to increase and fluidity is likely to be improved.

In Formula (X), R¹ is, for example, preferably a group represented by Formula (X-1), and more preferably a group having a carbon-carbon double bond with an electron attractive group (C═O). That is, R¹ is more preferably an acryloyl group or a methacryloyl group.

The reason for this is not clear, but thought to be as follows.

It is thought that in a case where R¹ is a group having a carbon-carbon double bond with an electron attractive group (C═O) in Formula (X), R¹ is likely to interact with the polar group (for example, carbonyl group or hydroxy group) of the cellulose acylate and enters between the cellulose acylate molecules. Accordingly, it is thought that pseudo-crosslinking is likely to be partially formed between the molecules, and as a result, the action of hydrogen bonding which may occur between the molecules lessens, and the melt viscosity is likely to fall.

In Formula (X), R² is, for example, preferably a hydrogen atom, an alkyl group having 1 to 6 carbon atoms (more preferably 1 to 3 carbon atoms), a phenyl group, or a benzyl group.

In Formula (X), for example, an aspect in which R¹ is a group represented by Formula (X-1), R² is a hydrogen atom, an alkyl group having 1 to 6 carbon atoms (more preferably 1 to 3 carbon atoms), a phenyl group, or a benzyl group, R³ is an alkylene group having 2 to 4 carbon atoms (more preferably 2 or 3 carbon atoms), and n is 2 or greater and 20 or less (more preferably 3 or greater and 10 or less) is preferable.

Hereinafter, specific examples of the polyether derivative (B) include a compound having the following structural formula, but are not limited thereto.

TABLE 1

| | | | | | | Weight | | | | |
|---|---|---|---|---|---|---|---|---|---|---|
| | | | | | | Average | | | | |
| | | | | | | Molec- | | | | |
| | | | | | | ular | | | | |
| | Structural Formula | Formula (X) | | | | Weight | SP Value (cal/cm³)^{1/2} | | | |
| | (Chemical Name) | R¹ | R³ | R² | n | (Mw) | δD | δP | δH | δ |
| PE1 | CH₂═CH—O—(C₂H₄O)ₙ—H | Vinyl | Ethylene | Hydrogen | 8 | 400 | 14.7 | 7.5 | 9.6 | 19.1 |
| | | Group | Group | Atom | | | | | | |
| PE2 | HC═C—CH₂—O—(C₂H₄O)ₙ—H | Propargyl | Ethylene | Hydrogen | 8 | 400 | 14.7 | 7.8 | 9.4 | 19.2 |
| | | Group | Group | Atom | | | | | | |
| PE3 | CH₂═CH—CH₂—O—(C₂H₄O)ₙ—Ph | Allyl | Ethylene | Phenyl | 6 | 400 | 15.5 | 5.6 | 6.9 | 17.9 |
| | | Group | Group | Group | | | | | | |
| PE4 | CH₂═CH—O—(C₂H₄O)ₙ—CH₂—Ph | Vinyl | Ethylene | Benzyl | 6 | 400 | 15.2 | 5.2 | 6.4 | 17.3 |
| | | Group | Group | Group | | | | | | |
| PE5 | CH₂═CH—CH₂—O—(C₂H₄O)ₙ—H | Allyl | Ethylene | Hydrogen | 9 | 450 | 14.2 | 7.5 | 9.4 | 18.6 |
| | (Polyethylene Glycol Allyl Ether) | Group | Group | Atom | | | | | | |
| PE6 | CH₂═CH—CH₂—O—(C₂H₄O)ₙ—CH₃ | Allyl | Ethylene | Methyl | 8.5 | 450 | 14.1 | 6.6 | 8 | 17.5 |
| | (Methoxy Polyethylene Glycol Allyl Ether) | Group | Group | Group | | | | | | |
| PE7 | CH₂═CH—CH₂—O— (C₂H₄O)ₙ—CH₃ | Allyl | Ethylene | Methyl | 11 | 550 | 13.3 | 7.1 | 8.7 | 17.5 |
| | (Methoxy Polyethylene Glycol Allyl Ether) | Group | Group | Group | | | | | | |
| PE8 | CH₂═CH—CH₂—O—(C₂H₄O)ₙ—CH₃ | Allyl | Ethylene | Methyl | 32 | 1500 | 5.7 | 11.7 | 16.5 | 21 |
| | (Methoxy Polyethylene Glycol Allyl Ether) | Group | Group | Group | | | | | | |
| PE9 | CH₂═CH—CH₂—O—(C₂H₄O)ₙ—CH₂—CH═CH₂ | Allyl | Ethylene | Allyl | 9 | 500 | 14 | 6.4 | 7.9 | 17.3 |
| | (Polyethylene Glycol Diallyl Ether) | Group | Group | Group | | | | | | |

TABLE 2

| | | | | | | Weight | | | | |
|---|---|---|---|---|---|---|---|---|---|---|
| | | | | | | Average | | | | |
| | | | | | | Molec- | | | | |
| | | | | | | ular | | | | |
| | Structural Formula | Formula (X) | | | | Weight | SP Value (cal/cm³)^{1/2} | | | |
| | (Chemical Name) | R¹ | R³ | R² | n | (Mw) | δD | δP | δH | δ |
| PE10 | CH₂═CH—CH₂—O—(C₂H₄O)ₙ—CH₂—CH═CH₂ | Allyl | Ethyl- | Allyl | 16 | 800 | 11.3 | 8.1 | 10.6 | 17.4 |
| | (Polyethylene Glycol Diallyl Ether) | Group | ene | Group | | | | | | |
| | | | Group | | | | | | | |
| PE11 | CH₂═CH—C(═O)O—(C₂H₄O)ₙ—H | Acryloyl | Ethyl- | Hydrogen | 4.5 | 270 | 15.9 | 7.8 | 10.5 | 20.6 |
| | (Polyethylene Glycol Monoacrylate) | Group | ene | Atom | | | | | | |
| | | | Group | | | | | | | |
| PE12 | CH₂═CH—C(═O)O—(C₂H₄O)ₙ—H | Acryloyl | Ethyl- | Hydrogen | 10 | 512 | 14 | 8.4 | 9.8 | 19.1 |
| | (Polyethylene Glycol Monoacrylate) | Group | ene | Atom | | | | | | |
| | | | Group | | | | | | | |
| PE13 | CH₂═CH—C(═O)O—(C₃H₆O)ₙ—H | Acryloyl | Propyl- | Hydrogen | 6 | 420 | 15.6 | 6.2 | 6.4 | 18.0 |
| | (Polypropylene Glycol Monoacrylate) | Group | ene | Atom | | | | | | |
| | | | Group | | | | | | | |
| PE14 | CH₂═CH—C(═O)O—(C₂H₄O)ₙ—C(═O)CH═CH₂ | Acryloyl | Ethyl- | Acryloyl | 9 | 522 | 14.5 | 7.2 | 8.2 | 18.2 |
| | (Polyethylene Glycol Diacrylate) | Group | ene | Group | | | | | | |
| | | | Group | | | | | | | |
| PE15 | CH₂═C(CH₃)—C(═O)O—(C₂H₄O)ₙ—C(═O)—C(CH₃)═CH₂ | Meth- | Ethyl- | Metha- | 4 | 330 | 16 | 5.5 | 6.5 | 18.1 |
| | (Polyethylene Glycol Dimethacrylate) | acryloyl | ene | cryloyl | | | | | | |
| | | Group | Group | Group | | | | | | |
| PE16 | CH₂═C(CH₃)—C(═O)O—(C₂H₄O)ₙ—C(═O)—C(CH₃)═CH₂ | Meth- | Ethyl- | Metha- | 9 | 550 | 14.4 | 6.7 | 7.5 | 17.5 |
| | (Polyethylene Glycol Dimethacrylate) | acryloyl | ene | cryloyl | | | | | | |
| | | Group | Group | Group | | | | | | |

| | | | | | | | |
|---|---|---|---|---|---|---|---|
| PE17 | CH₂═CH—CH₂—O—(C₃H₆O)ₙ—CH₂—CH═CH₂ | Allyl | Propyl- | Allyl | 50 | 3000 | Calculation is |
| | (Polypropylene Glycol Diallyl Ether) | Group | ene | Group | | | impossible since the |
| | | | Group | | | | molecular weight is |
| | | | | | | | too high. |

As the polyether derivative (B), a commercially available product may be used. Examples of the commercially available product include “UNIOX” manufactured by NOF CORPORATION, “BLEMMER” manufactured by NOF CORPORATION, and “ALLYL GLYCOL H” manufactured by NIPPON NYUKAZAI CO., LTD.

Weight Average Molecular Weight (Mw)

The weight average molecular weight (Mw) of the polyether derivative (B) is, for example, preferably 200 or greater and 3,000 or less, more preferably 250 or greater and 2,000 or less, and even more preferably 300 or greater and 1,000 or less.

In a case where the weight average molecular weight (Mw) of the polyether derivative (B) is 200 or greater, a resin molded article in which bleeding is suppressed is easily obtained.

In a case where the weight average molecular weight (Mw) is 3,000 or less, affinity with the cellulose acylate (A) is likely to increase and fluidity is likely to be improved.

The weight average molecular weight (Mw) is a value measured based on the method of measuring the weight average molecular weight (Mw) of the cellulose acylate (A) described above.

Solubility Parameter (SP value)

The solubility parameter (SP value) of the polyether derivative (B) is, for example, preferably 17 (cal/cm³)^{1/2} or greater and 21 (cal/cm³)^{1/2} or less, more preferably 17 (cal/cm³)^{1/2} or greater and 20 (cal/cm³)^{1/2} or less, and even more preferably 17 (cal/cm³)^{1/2} or greater and 19 (cal/cm³)^{1/2} or less.

“1 cal/cm³≈4.168 J/cm³” is set.

In a case where the solubility parameter (SP value) of the polyether derivative (B) is 17 (cal/cm³)^{1/2} or greater and 21 (cal/cm³)^{1/2} or less, affinity with the cellulose acylate (A) is likely to increase and fluidity is likely to be improved. Furthermore, noise is likely to be reduced during the molding and the mechanical strength is also likely to be ensured.

Here, the solubility parameter (SP value) in the exemplary embodiment will be described.

In the exemplary embodiment, Hansen's solubility parameter is used as the SP value. The Hansen solubility parameter is a parameter obtained by dividing Hildebrand's solubility parameter into three elements, that is, a dispersion term δD, a polarity term δP, and a hydrogen bond term δH, and expressing them in a three-dimensional space. In the exemplary embodiment, a value calculated using the following expression is used. Software (HSPiP ver. 4. 1. 07) is used for calculation.

Solubility Parameter: δ=(δD²+δP²+δH²)^{1/2}

Each of δD, δP, and δH of the polyether derivative (B) may be within the following range from the viewpoint of increasing the affinity with the cellulose acylate (A).

δD of the polyether derivative (B) is, for example, preferably greater than 13 and less than 18, more preferably greater than 14 and less than 17, and even more preferably greater than 14 and less than 16.

δP of the polyether derivative (B) is, for example, preferably greater than 5 and less than 9, more preferably greater than 5.5 and less than 8.5, and even more preferably greater than 6 and less than 8.

δH of the polyether derivative (B) is, for example, preferably greater than 6 and less than 11, more preferably greater than 6.5 and less than 10.5, and even more preferably greater than 7 and less than 10.

Absolute Value of Difference Between SP Value of Polyether Derivative (B) and SP Value of Cellulose Acylate (A)

The absolute value of the difference is, for example, preferably 1 or greater and less than 10, more preferably 2 or greater and 9 or less, and even more preferably 3 or greater and 8 or less.

Here, the fact that the absolute value of the difference is 1 or greater and 10 or less means that the SP value of the polyether derivative (B) and the SP value of the cellulose acylate (A) are values close to each other appropriately. In other words, the above fact means that the SP value of the polyether derivative (B) and the SP value of the cellulose acylate (A) are values not too close to each other.

Accordingly, it is thought that the affinity between the polyether derivative (B) and the cellulose acylate (A) are likely to further increase, and as a result, the fluidity is likely to be improved.

The reason for this is not clear, but thought to be as follows.

In order to improve the fluidity, for example, it is preferable that the affinity between the cellulose acylate (A) and the polyether derivative (B) is high, that is, the SP values thereof are close to each other to some extent. However, a case where the SP values thereof are too close to each other means that the affinity of the entire molecules is high. In this case, there is a tendency that the cellulose acylate (A) and the polyether derivative (B) are too close to each other, and thus it is thought that the space therebetween is not sufficiently widened and the fluidity is reduced. Accordingly, it is assumed that in a case where a functional group or the like which is not too high in affinity with the cellulose acylate (A) is included in the polyether derivative (B), repulsion between the cellulose acylate (A) and the polyether derivative (B) is appropriately promoted and the fluidity can be increased.

The SP value of a cellulose acetate is generally 20.5 or greater and 22.5 or less, and the SP value of a cellulose acetate propionate is generally 17 or greater and 18 or less.

The content of the polyether derivative (B) is, for example, preferably 1.0 mass % or greater and 30 mass % or less, more preferably 5 mass % or greater and 25 mass % or less, and even more preferably 10 mass % or greater and 20 mass % or less with respect to 100 parts by mass of the cellulose acylate (A).

Plasticizer

The resin composition according to the exemplary embodiment may further contain a plasticizer.

The content of the plasticizer may be 15 mass % or less (preferably 10 mass % or less, and more preferably 5 mass % or less) with respect to the entire resin composition. In a case where the content of the plasticizer is within the above range, bleeding of the plasticizer is likely to be suppressed.

Examples of the plasticizer include an adipic acid ester-containing compound, a polyether ester compound, a sebacic acid ester compound, a glycol ester compound, an acetic acid ester, a dibasic acid ester compound, a phosphoric acid ester compound, a phthalic acid ester compound, camphor, citric acid ester, stearic acid ester, metallic soap, polyol, and polyalkylene oxide.

Among these, for example, an adipic acid ester-containing compound is preferable.

Adipic Acid Ester-Containing Compound

An adipic acid ester-containing compound (compound containing adipic acid ester) refers to a compound of an adipic acid ester alone, or a mixture of an adipic acid ester and components other than the adipic acid ester (compound different from the adipic acid ester). The adipic acid ester-containing compound may contain 50 mass % or greater of the adipic acid ester with respect to all the components.

Examples of the adipic acid ester include adipic acid diester and adipic acid polyester. Specifically, adipic acid diester represented by Formula (AE-1) and adipic acid polyester represented by Formula (AE-2) are exemplified.

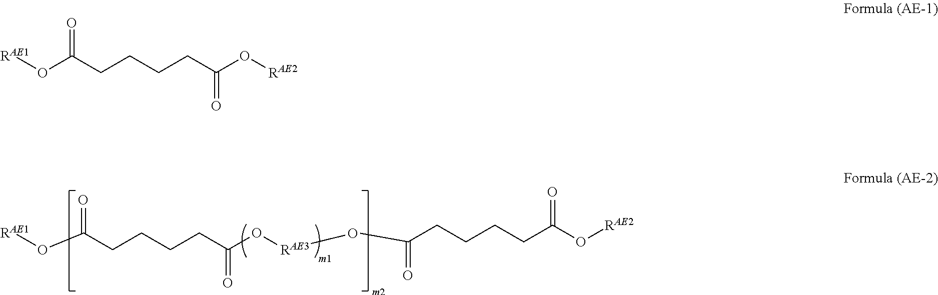

In Formulae (AE-1) and (AE-2), R^{AE1} and R^{AE2} each independently represents an alkyl group or a polyoxyalkyl group [—(CₓH₂ₓ₋O)_{y-}R^{A1}] (provided that R^{A1} represents an alkyl group, x represents an integer of 1 to 10, and y represents an integer of 1 to 10).

R^{AE3} represents an alkylene group.

m1 represents an integer of 1 to 20.

m2 represents an integer of 1 to 10

In Formulae (AE-1) and (AE-2), the alkyl group represented by R^{AE1} or R^{AE2} are, for example, preferably an alkyl group having 1 to 6 carbon atoms, and more preferably an alkyl group having 1 to 4 carbon atoms. The alkyl group represented by R^{AE1} or R^{AE2} may be linear, branched, or cyclic, and is, for example, preferably linear or branched.

In Formulae (AE-1) and (AE-2), in the polyoxyalkyl group [—(CₓH₂ₓ₋O)_{y}—R^{A1}] represented by R^{AE1} or R^{AE2}, the alkyl group represented by R^{A1} is, for example, preferably an alkyl group having 1 to 6 carbon atoms, and more preferably an alkyl group having 1 to 4 carbon atoms. The alkyl group represented by R^{A1} may be linear, branched, or cyclic, and is, for example, preferably linear or branched.

In Formula (AE-2), the alkylene group represented by R^{AE3} is, for example, preferably an alkylene group having 1 to 6 carbon atoms, and more preferably an alkylene group having 1 to 4 carbon atoms. The alkylene group may be linear, branched, or cyclic, and is, for example, preferably linear or branched.

In Formulae (AE-1) and (AE-2), the group represented by each symbol may be substituted with a substituent. Examples of the substituent include an alkyl group, an aryl group, and a hydroxyl group.

The molecular weight (or weight average molecular weight) of the adipic acid ester is, for example, preferably 200 or greater and 5,000 or less, and more preferably 300 or greater and 2,000 or less. The weight average molecular weight is a value measured based on the method of measuring the weight average molecular weight of the cellulose acylate (A) described above.

Hereinafter, specific examples of the adipic acid ester-containing compound will be shown, but are not limited thereto.

TABLE 3

| | Substance Name | Product Name | Manufacturer |
|---|---|---|---|
| ADP1 | Adipic | Daifatty | DAIHACHI CHEMICAL |
| | Acid Diester | 101 | INDUSTRY CO., LTD. |
| ADP2 | Adipic | ADEKACIZER | ADEKA |
| | Acid Diester | RS-107 | |
| ADP3 | Adipic | POLYCIZER | DIC |
| | Acid Polyester | W-230-H | |

Other Components

The resin composition according to the exemplary embodiment may further include a component other than the above-described components if necessary. Examples of the component include a flame retardant, a compatibilizer, an antioxidant, a release agent, a light-resistant agent, a weather-resistant agent, a colorant, a pigment, a modifier, a drip preventing agent, an antistatic agent, a hydrolysis inhibitor, a filler, and a reinforcing agent (glass fiber, carbon fiber, talc, clay, mica, glass flakes, milled glass, glass beads, crystalline silica, alumina, silicon nitride, aluminum nitride, boron nitride, and the like).

If necessary, a component (additive) such as an acid acceptor for preventing acetic acid release or a reactive trapping agent may be added. Examples of the acid acceptor include oxides such as magnesium oxide and aluminum oxide; metallic hydroxides such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The content of each of these components is, for example, preferably 0 mass % or greater and 5 mass % or less with respect to the total amount of the resin composition. Here, “0 mass %” means that the resin composition does not contain other components.

The resin composition according to the exemplary embodiment may include a resin other than the above-described resins (cellulose acylate (A) and polyether derivative (B)). The ratio of the resin other than the above-described resins with respect to all the resins is, for example, preferably 20 mass % or less, more preferably 15 mass % or less, and even more preferably 10 mass % or less.

Examples of other resins include thermoplastic resins which have been known. Specific examples thereof include polycarbonate resins; polypropylene resins; polyester resins; polyolefin resins; polyester carbonate resins; polyphenylene ether resins, polyphenylene sulfide resins; polysulfone resins; polyether sulfone resins; polyarylene resins; polyether imide resins; polyacetal resins; polyvinyl acetal resins; polyketone resins; polyether ketone resins; polyether ether ketone resins; polyaryl ketone resins; polyether nitrile resins; liquid crystal resins; polybenzimidazole resins; polyparabanic acid resins; vinyl polymers or copolymers obtained by polymerizing or copolymerizing one or more kinds of vinyl monomers selected from the group consisting of aromatic alkenyl compounds, methacrylic acid esters, acrylic acid esters, and vinyl cyanide compounds; diene-aromatic alkenyl compound copolymers; vinyl cyanide-diene-aromatic alkenyl compound copolymers; aromatic alkenyl compound-diene-vinyl cyanide-N-phenyl maleimide copolymers; vinyl cyanide-(ethylene-diene-propylene (EPDM))-aromatic alkenyl compound copolymers; vinyl chloride resins; and chlorinated vinyl chloride resins. A core-shell-type butadiene-methyl methacrylate copolymer is also included. These resins maybe used alone or in combination of two or more kinds thereof.

Method of Producing Resin Composition

The resin composition according to the exemplary embodiment is produced by melt-kneading a mixture including the cellulose acylate (A), the polyether derivative (B) described above, and if necessary, a plasticizer and other components. The resin composition according to the exemplary embodiment is also produced by dissolving the above-described components in a solvent.

Examples of the unit for melt-kneading include known units. Specific examples thereof include a twin-screw extruder, a HENSCHEL MIXER, a BANBURY MIXER, a single-screw extruder, a multi-screw extruder, and a co-kneader.

During the kneading, the temperature may be determined in accordance with the melting temperature of the cellulose acylate (A) to be used. The temperature is, for example, preferably 140° C. or higher and 240° C. or lower, and more preferably 160° C. or higher and 200° C. or lower in view of thermal decomposition and fluidity.

Resin Molded Article

A resin molded article according to the exemplary embodiment is provided by molding the resin composition according to the exemplary embodiment. That is, the resin molded article is obtained by molding a resin composition including the cellulose acylate (A) and the polyether derivative (B) described above.

As the molding method, for example, injection molding, extrusion, blow molding, hot press molding, calendaring, coating molding, cast molding, dipping molding, vacuum molding, transfer molding, or the like may be applied.

As the method of molding a resin molded article according to the exemplary embodiment, for example, injection molding is preferable in view of high shape flexibility. Regarding injection molding, a resin composition according to the exemplary embodiment is melted by heating, poured into a mold, and solidified to obtain a molded article. The molding may be performed by injection compression molding.

The cylinder temperature in the injection molding is, for example, preferably 200° C. or higher and 250° C. or lower, more preferably 210° C. and 240° C. or lower, and even more preferably 210° C. or higher and 230° C. or lower. The mold temperature in the injection molding is, for example, preferably 40° C. or higher and 70° C. or lower, more preferably 45° C. or higher and 65° C. or lower, and even more preferably 45° C. or higher and 60° C. or lower. The injection molding may be performed using commercially available equipment, such as NEX500 manufactured by NISSEI PLASTIC INDUSTRIAL CO., LTD., NEX150 manufactured by NISSEI PLASTIC INDUSTRIAL CO., LTD., NEX70000 manufactured by NISSEI PLASTIC INDUSTRIAL CO., LTD., or SE50D manufactured by TOSHIBA MACHINE CO., LTD.

The resin molded article according to the exemplary embodiment may be used for electronic or electric equipment, office equipment, home appliances, automobile interior materials, containers, or the like. More specifically, the resin molded article is used for housings of electronic or electric equipment or home appliances; various components of electronic or electric equipment or home appliances; interior parts of automobiles; storage cases of CD-ROMs, DVDs, or the like; dishes; beverage bottles; food trays; wrapping materials; films; or sheets.

### EXAMPLES

Hereinafter, the invention will be described in more detail with reference to examples, but is not limited to these examples. Here, “parts” represent “parts by mass” unless otherwise noted.

Synthesis and Preparation of Cellulose Acylate (A)

As a cellulose acylate (A), cellulose acetates CA1 to CA6, CA8, and CA9 are synthesized by the following method. In addition, commercially available cellulose acetates CA7-1 to CA7-3 and a cellulose acetate propionate CAP are prepared.

Synthesis of Cellulose Acetate CA1

Acetylation: 3 parts of a cellulose powder (manufactured by NIPPON PAPER Chemicals CO., LTD., KC FLOCK W50), 0.15 parts of a sulfuric acid, 30 parts of an acetic acid, and 6 parts of acetic anhydride are put into a reaction container and stirred for 4 hours at 20° C. to perform the acetylation of the cellulose.

Deacetylation and Molecular Weight Reduction: After the stirring of the acetylated solution is completed, 3 parts of an acetic acid and 1.2 parts of pure water are immediately added and stirring is performed for 30 minutes at 20° C. Then, 4.5 parts of a 0.2 M-hydrochloric acid aqueous solution is added, and the resulting solution is heated at 75° C. and stirred for 5 hours. This solution is added dropwise to 200 parts of pure water for 2 hours and left for 20 hours, and then filtered through a filter having a pore diameter of 6 μm, whereby 4 parts of a white powder is obtained.

Washing: The obtained white powder is washed using a filter press (manufactured by KURITA MACHINERY MFG. CO., LTD., SF (PP)) with pure water until the conductivity is 50 μS or less. Then, the powder is dried.

Post-processing: 0.2 parts of calcium acetate and 30 parts of pure water are added to 3 parts of the white powder after the drying, and stirring is performed for 2 hours at 25° C. Then, the resulting material is filtered and the obtained powder is dried for 72 hours at 60° C. to obtain approximately 2.5 parts of a cellulose acetate CA1.

Synthesis of Cellulose Acetate CA2

A cellulose acetate CA2 is obtained in the same manner as in the case of CA1, except that the amount of the sulfuric acid used for the acetylation is changed from 0.15 parts to 0.30 parts.

Synthesis of Cellulose Acetate CA3

A cellulose acetate CA3 is obtained in the same manner as in the case of CA1, except that the amount of the sulfuric acid used for the acetylation is changed from 0.15 parts to 0.03 parts.

Synthesis of Cellulose Acetate CA4

A cellulose acetate CA4 is obtained in the same manner as in the case of CA1, except that in the deacetylation and molecular weight reduction, the stirring is performed for 7 hours, not for 5 hours.

Synthesis of Cellulose Acetate CA5

A cellulose acetate CA5 is obtained in the same manner as in the case of CA1, except that in the deacetylation and molecular weight reduction, the stirring is performed for 7 hours at 65° C., not for 5 hours at 75° C.

Synthesis of Cellulose Acetate CA6

A cellulose acetate CA6 is obtained in the same manner as in the case of CA1, except that in the deacetylation and molecular weight reduction, the stirring is performed for 4 hours at 80° C., not for 5 hours at 75° C.

Preparation of Cellulose Acetates CA7-1 to CA7-3

As a cellulose acetate (A), commercially available cellulose acetates CA7-1 to CA7-3 are prepared. Details thereof are as follows.

Cellulose Acetate CA7-1: manufactured by DAICEL CORPORATION, L-50

Cellulose Acetate CA7-2: manufactured by DAICEL CORPORATION, L-20

Cellulose Acetate CA7-3: manufactured by EASTMAN CHEMICAL COMPANY, CA-398-3

Synthesis of Cellulose Acetate CA8

A cellulose acetate CA8 is obtained in the same manner as in the case of CA1, except that in the deacetylation and molecular weight reduction, the stirring is performed for 4 hours 30 minutes, not for 5 hours.

Synthesis of Cellulose Acetate CA9

A cellulose acetate CA9 is obtained in the same manner as in the case of CA1, except that the solution obtained by the acetylation is left for 10 hours at room temperature (20° C., the same hereinbelow), and then subjected to the deacetylation and molecular weight reduction.

Cellulose Acetate Propionate CAP

CAP-482-20 manufactured by EASTMAN CHEMICAL COMPANY is used as a cellulose acetate propionate CAP.

Measurement of Weight Average Molecular Weight (Mw), Polymerization Degree, and Substitution Degree

The weight average molecular weight (Mw) and the substitution degree of the cellulose acylate are measured through the above-described method. The polymerization degree of the cellulose acylate is obtained by dividing the weight average molecular weight (Mw) of the cellulose acylate by a constituent unit molecular weight of the cellulose acylate. For example, in a case where the degree of substitution with acetyl group is 2.4, the constituent unit molecular weight is 263, and in a case where the degree of substitution is 2.9, the constituent unit molecular weight is 287. The measured weight average molecular weight (Mw), polymerization degree, and substitution degree of the cellulose acylate are arranged in Table 4.

TABLE 4

| | | | Polymerization | Substitution |
|---|---|---|---|---|
| | Substituent | Mw | Degree | Degree |
| CA1 | Acetyl Group | 76,700 | 300 | 2.25 |
| CA2 | Acetyl Group | 40,500 | 160 | 2.20 |
| CA3 | Acetyl Group | 86,300 | 325 | 2.45 |
| CA4 | Acetyl Group | 32,600 | 130 | 2.15 |
| CA5 | Acetyl Group | 88,000 | 320 | 2.65 |
| CA6 | Acetyl Group | 61,500 | 250 | 2.05 |
| CA7-1 | Acetyl Group | 160,000 | 607 | 2.41 |
| CA7-2 | Acetyl Group | 117,800 | 447 | 2.41 |
| CA7-3 | Acetyl Group | 79,000 | 300 | 2.40 |
| CA8 | Acetyl Group | 94,700 | 350 | 2.55 |
| CA9 | Acetyl Group | 29,100 | 115 | 2.25 |
| CAP | Acetyl Group or | 200,000 | 717 | 2.60 |
| | Propionyl Group | | | |

Preparation of Polyether Derivative (B)

As a polyether derivative (B), commercially available polyether derivatives PE1 to PE17 shown in Tables 5 and 6 are prepared. In Tables 5 and 6, “ph” represents a phenyl group.

TABLE 5

| | | | | | | Weight | | | | |
|---|---|---|---|---|---|---|---|---|---|---|
| | | | | | | Average | | | | |
| | | | | | | Molec- | | | | |
| | | | | | | ular | | | | |
| | Structural Formula | Formula (X) | | | | Weight | SP Value (cal/cm³)^{1/2} | | | |
| | (Chemical Name) | R1 | R3 | R2 | n | (Mw) | δD | δP | δH | δ |
| PE1 | CH₂═CH—O—(C₂H₄O)ₙ—H | Vinyl | Ethylene | Hydrogen | 8 | 400 | 14.7 | 7.5 | 9.6 | 19.1 |
| | | Group | Group | Atom | | | | | | |
| PE2 | HC═C—CH₂—O—(C₂H₄O)ₙ—H | Propargyl | Ethylene | Hydrogen | 8 | 400 | 14.7 | 7.8 | 9.4 | 19.2 |
| | | Group | Group | Atom | | | | | | |
| PE3 | CH₂═CH—CH₂—O—(C₂H₄O)ₙ—Ph | Allyl | Ethylene | Phenyl | 6 | 400 | 15.5 | 5.6 | 6.9 | 17.9 |
| | | Group | Group | Group | | | | | | |
| PE4 | CH₂═CH—O— (C₂H₄O) ₙ—CH₂—Ph | Vinyl | Ethylene | Benzyl | 6 | 400 | 15.2 | 5.2 | 6.4 | 17.3 |
| | | Group | Group | Group | | | | | | |
| PE5 | CH₂═CH—CH₂—O—(C₂H₄O)ₙ—H | Allyl | Ethylene | Hydrogen | 9 | 450 | 14.2 | 7.5 | 9.4 | 18.6 |
| | (Polyethylene Glycol Allyl Ether) | Group | Group | Atom | | | | | | |
| PE6 | CH₂═CH—CH₂—O—(C₂H₄O)ₙ—CH₃ | Allyl | Ethylene | Methyl | 8.5 | 450 | 14.1 | 6.6 | 8 | 17.5 |
| | (Methoxy Polyethylene Glycol Allyl Ether) | Group | Group | Group | | | | | | |
| PE7 | CH₂═CH—CH₂—O—(C₂H₄O)ₙ—CH₃ | Allyl | Ethylene | Methyl | 11 | 550 | 13.3 | 7.1 | 8.7 | 17.5 |
| | (Methoxy Polyethylene Glycol Allyl Ether) | Group | Group | Group | | | | | | |
| PE8 | CH₂═CH—CH₂—O—(C₂H₄O)ₙ—CH₃ | Allyl | Ethylene | Methyl | 32 | 1500 | 5.7 | 11.7 | 16.5 | 21 |
| | (Methoxy Polyethylene Glycol Allyl Ether) | Group | Group | Group | | | | | | |
| PE9 | CH₂═CH—CH₂—O—(C₂H₄O)ₙ—CH₂—CH═CH₂ | Allyl | Ethylene | Allyl | 9 | 500 | 14 | 6.4 | 7.9 | 17.3 |
| | (Polyethylene Glycol Diallyl Ether) | Group | Group | Group | | | | | | |

TABLE 6

| | | | | | | Weight | | | | |
|---|---|---|---|---|---|---|---|---|---|---|
| | | | | | | Average | | | | |
| | | | | | | Molec- | | | | |
| | | | | | | ular | | | | |
| | Structural Formula | Formula (X) | | | | Weight | SP Value (cal/cm³)^{1/2} | | | |
| | (Chemical Name) | R¹ | R³ | R² | n | (Mw) | δD | δP | δH | δ |
| PE10 | CH₂═CH—CH₂—O—(C₂H₄O)ₙ—CH₂—CH═CH₂ | Allyl | Ethyl- | Allyl | 16 | 800 | 11.3 | 8.1 | 10.6 | 17.4 |
| | (Polyethylene Glycol Diallyl Ether) | Group | ene | Group | | | | | | |
| | | | Group | | | | | | | |
| PE11 | CH₂═CH—C(═O)O—(C₂H₄O)ₙ—H | Acryloyl | Ethyl- | Hydrogen | 4.5 | 270 | 15.9 | 7.8 | 10.5 | 20.6 |
| | (Polyethylene Glycol Monoacrylate) | Group | ene | Atom | | | | | | |
| | | | Group | | | | | | | |
| PE12 | CH₂═CH—C(═O)O—(C₂H₄O)ₙ—H | Acryloyl | Ethyl- | Hydrogen | 10 | 512 | 14 | 8.4 | 9.8 | 19.1 |
| | (Polyethylene Glycol Monoacrylate) | Group | ene | Atom | | | | | | |
| | | | Group | | | | | | | |
| PE13 | CH₂═CH—C(═O)O—(C₃H₆O)ₙ—H | Acryloyl | Propyl- | Hydrogen | 6 | 420 | 15.6 | 6.2 | 6.4 | 18.0 |
| | (Polypropylene Glycol Monoacrylate) | Group | ene | Atom | | | | | | |
| | | | Group | | | | | | | |
| PE14 | CH₂═CH—C(═O)O—(C₂H₄O)ₙ—C(═O)—CH═CH₂ | Acryloyl | Ethyl- | Acryloyl | 9 | 522 | 14.5 | 7.2 | 8.2 | 18.2 |
| | (Polyethylene Glycol Diacrylate) | Group | ene | Group | | | | | | |
| | | | Group | | | | | | | |
| PE15 | CH₂═C(CH₃)—C(═O)O—(C₂H₄O)ₙ—C(═O)—C(CH₃)═CH₂ | Metha- | Ethyl- | Metha- | 4 | 330 | 16 | 5.5 | 6.5 | 18.1 |
| | (Polyethylene Glycol Dimethacrylate) | cryloyl | ene | cryloyl | | | | | | |
| | | Group | Group | Group | | | | | | |
| PE16 | CH₂═C(CH₃)—C(═O)O—(C₂H₄O)ₙ—C(═O)—C(CH₃)═CH₂ | Metha- | Ethyl- | Metha- | 9 | 550 | 14.4 | 6.7 | 7.5 | 17.5 |
| | (Polyethylene Glycol Dimethacrylate) | cryloyl | ene | cryloyl | | | | | | |
| | | Group | Group | Group | | | | | | |

| | | | | | | | |
|---|---|---|---|---|---|---|---|
| PE17 | CH₂═CH—CH₂—O—(C₃H₆O)ₙ—CH₂—CH═CH₂ | Allyl | Propyl- | Allyl | 50 | 3000 | Calculation is |
| | (Polypropylene Glycol Diallyl Ether) | Group | ene | Group | | | impossible since the |
| | | | Group | | | | molecular weight is |
| | | | | | | | too high. |

The following commercially available products are used as PE5 to PE17 among the polyether derivatives described in Tables 5 and 6.

PE5: UNIOX PKA-5003, manufactured by NOF CORPORATION

PE6: UNIOX PKA-5008, manufactured by NOF CORPORATION

PE7: UNIOX PKA-5009, manufactured by NOF CORPORATION

PE8: UNIOX PKA-5010, manufactured by NOF CORPORATION

PE9: UNIOX AA-480R, manufactured by NOF CORPORATION

PE10: UNIOX AA-800, manufactured by NOF CORPORATION

PE11: BLEMMER AE-200, manufactured by NOF CORPORATION

PE12: BLEMMER AE-400, manufactured by NOF CORPORATION

PE13: BLEMMER AP-400, manufactured by NOF CORPORATION

PE14: BLEMMER ADE-400A, manufactured by NOF CORPORATION

PE15: BLEMMER PDE-200, manufactured by NOF CORPORATION

PE16: BLEMMER PDE-400, manufactured by NOF CORPORATION

PE17: UNISAFE PKA-5018, manufactured by NOF CORPORATION

Preparation of Other Additives

The following plasticizers A to C are prepared as other additives.

Plasticizer A: Adipic acid ester-containing compound (manufactured by DAIHACHI CHEMICAL INDUSTRY CO., LTD., Daifatty 101)

Plasticizer B: Polyether esters (manufactured by ADEKA CORPORATION, ADEKACIZER RS1000)

Plasticizer C: Polyethylene glycol (PEG, manufactured by NOF CORPORATION, PEG#400)

In the following tables, “Daifatty 101” represents the plasticizer A, “RS1000” represents the plasticizer B, and “PEG” represents the plasticizer C.

### Examples 1 to 16 and Comparative Examples 1 to 4

First, Examples 1 to 16 obtained by adding the various polyether derivatives (B) to the cellulose acetate CA7-3, Comparative Examples 1 to 3 obtained by adding the same amount of plasticizer in place of the polyether derivative (B), and Comparative Example 4 including the cellulose acetate CA7-3 only will be shown.

Production of Resin Composition (Pellets)

A resin composition (pellets) is obtained using a twin-screw kneader (manufactured by TOSHIBA MACHINE CO., LTD, TEX41SS) at a charge composition ratio and a temperature shown in Tables 7 to 9.

Injection Molding of Dumbbell and Test Piece D2

The obtained pellets are put into an injection molding machine (manufactured by NISSEI PLASTIC INDUSTRIAL CO., LTD., NEX500) and injection-molded under conditions of a cylinder temperature and a mold temperature shown in Tables 7 to 9. A dumbbell test piece (JIS K 7139A1) and a test piece D2 (length: 60 mm, width: 60 mm, thickness: 2 mm) are obtained as resin molded articles.

TABLE 7

| | | | Example 1 | Example 2 | Example 3 | Example 4 | Example 5 | Example 6 | Example 7 | Example 8 |
|---|---|---|---|---|---|---|---|---|---|---|
| Charge | Cellulose | Kind | CA7-3 | CA7-3 | CA7-3 | CA7-3 | CA7-3 | CA7-3 | CA7-3 | CA7-3 |
| Composition | Acylate (A) | Parts by | 100 | 100 | 100 | 100 | 100 | 100 | 100 | 100 |
| Ratio | | Mass | | | | | | | | |
| | Polyether | Product | PKA-5008 | PKA-5003 | PKA-5009 | PKA-5010 | AA-480R | AA-800 | AE-200 | AE-400 |
| | Derivative | Name | (PE6) | (PE5) | (PE7) | (PE8) | (PE9) | (PE10) | (PE11) | (PE12) |
| | (B) | (Kind) | | | | | | | | |
| | | Parts by | 15 | 15 | 15 | 15 | 15 | 15 | 15 | 15 |
| | | Mass | | | | | | | | |
| | | Product | — | — | — | — | — | — | — | — |
| | | Name | | | | | | | | |
| | | (Kind) | | | | | | | | |
| | | Parts by | — | — | — | — | — | — | — | — |
| | | Mass | | | | | | | | |
| | Other | Kind | — | — | — | — | — | — | — | — |
| | Additives | Parts by | — | — | — | — | — | — | — | — |
| | | Mass | | | | | | | | |
| Kneading | Cylinder | ° C. | 220 | 220 | 220 | 220 | 220 | 220 | 220 | 220 |
| | Temperature | | | | | | | | | |
| Molding | Cylinder | ° C. | 220 | 220 | 220 | 220 | 220 | 220 | 220 | 220 |
| | Temperature | | | | | | | | | |
| | Mold | ° C. | 60 | 60 | 60 | 60 | 60 | 60 | 60 | 60 |
| | Temperature | | | | | | | | | |
| Continuous Moldability | | | A | A | A | A | A | A | A | A |
| Screw Noise | | | A | A | A | A | A | A | A | A |
| Melt Viscosity | | Pa · s | 253 | 234 | 288 | 297 | 264 | 274 | 236 | 248 |
| (220° C., 1216 s⁻¹) | | | | | | | | | | |
| Melt Viscosity | | Pa · s | — | — | — | — | — | — | — | — |
| (200° C., 1216 s⁻¹) | | | | | | | | | | |
| Mechanical | Tensile | MPa | 68 | 67 | 67 | 65 | 67 | 64 | 67 | 65 |
| Strength | Stress | | | | | | | | | |
| | Tensile | % | 14.3 | 13.2 | 13.5 | 14.6 | 14.7 | 15.1 | 11.1 | 11.4 |
| | Elongation | | | | | | | | | |
| | at Break | | | | | | | | | |
| | Charpy | KJ/m² | 13.4 | 12.8 | 13.2 | 13.6 | 12.6 | 13.8 | 12.2 | 12.1 |
| | Impact | | | | | | | | | |
| | Strength | | | | | | | | | |

| | | | | | | | | | |
|---|---|---|---|---|---|---|---|---|---|
| Degree of Brown Coloring | — | 130 | 130 | 130 | 130 | 130 | 130 | 130 | 130 |
| (APHA Method) | | | | | | | | | |
| Transparency Degree | % | 95 | 94 | 94 | 94 | 94 | 94 | 93 | 92 |
| (Total Light Transmittance) | | | | | | | | | |

| | | | | | | | | |
|---|---|---|---|---|---|---|---|---|
| Bleeding Property | 5 | 4 | 5 | 5 | 5 | 5 | 5 | 5 |

TABLE 8

| | | | Exam- | Exam- | Exam- | Exam- | Exam- | Exam- | Exam- | Exam- |
|---|---|---|---|---|---|---|---|---|---|---|
| | | | ple 9 | ple 10 | ple 11 | ple 12 | ple 13 | ple 14 | ple 15 | ple 16 |
| Charge | Cellulose | Kind | CA7-3 | CA7-3 | CA7-3 | CA7-3 | CA7-3 | CA7-3 | CA7-3 | CA7-3 |
| Composition | Acylate (A) | Parts by | 100 | 100 | 100 | 100 | 100 | 100 | 100 | 100 |
| Ratio | | Mass | | | | | | | | |
| | Polyether | Product | AP-400 | PDE-200 | PDE-400 | ADE400A | — | — | — | — |
| | Derivative | Name | (PE13) | (PE15) | (PE16) | (PE14) | (PE1) | (PE2) | (PE3) | (PE4) |
| | (B) | (Kind) | | | | | | | | |
| | | Parts by | 15 | 15 | 15 | 15 | 15 | 15 | 15 | 15 |
| | | Mass | | | | | | | | |
| | | Product | — | — | — | — | — | — | — | — |
| | | Name | | | | | | | | |
| | | (Kind) | | | | | | | | |
| | | Parts by | — | — | — | — | — | — | — | — |
| | | Mass | | | | | | | | |
| | Other | Kind | — | — | — | — | — | — | — | — |
| | Additives | Parts by | — | — | — | — | — | — | — | — |
| | | Mass | | | | | | | | |
| Kneading | Cylinder | ° C. | 220 | 220 | 220 | 220 | 220 | 220 | 220 | 220 |
| | Temperature | | | | | | | | | |
| Molding | Cylinder | ° C. | 220 | 220 | 220 | 220 | 220 | 220 | 220 | 220 |
| | Temperature | | | | | | | | | |
| | Mold | ° C. | 60 | 60 | 60 | 60 | 60 | 60 | 60 | 60 |
| | Temperature | | | | | | | | | |
| Continuous Moldability | | | A | A | A | A | A | A | A | A |
| Screw Noise | | | A | A | A | A | A | A | A | A |
| Melt Viscosity | | Pa · s | 241 | 269 | 271 | 253 | 245 | 257 | 308 | 311 |
| (220° C., 1216 s⁻¹) | | | | | | | | | | |
| Melt Viscosity | | Pa · s | — | — | — | — | — | — | — | — |
| (200° C., 1216 s⁻¹) | | | | | | | | | | |
| Mechanical | Tensile | MPa | 66 | 67 | 67 | 67 | 67 | 68 | 67 | 67 |
| Strength | Stress | | | | | | | | | |
| | Tensile | % | 10.8 | 11.3 | 12.5 | 12.8 | 13.7 | 13.4 | 13.5 | 14.1 |
| | Elongation | | | | | | | | | |
| | at Break | | | | | | | | | |
| | Charpy | KJ/m² | 13.5 | 12.5 | 12.1 | 12.7 | 12.1 | 13.1 | 12.6 | 12.5 |
| | Impact | | | | | | | | | |
| | Strength | | | | | | | | | |

| | | | | | | | | | |
|---|---|---|---|---|---|---|---|---|---|
| Degree of Brown Coloring | — | 130 | 130 | 130 | 130 | 130 | 130 | 130 | 130 |
| (APHA Method) | | | | | | | | | |
| Transparency Degree | % | 90 | 93 | 92 | 92 | 93 | 92 | 92 | 95 |
| (Total Light Transmittance) | | | | | | | | | |

| | | | | | | | | |
|---|---|---|---|---|---|---|---|---|
| Bleeding Property | 5 | 5 | 5 | 5 | 5 | 5 | 5 | 5 |

TABLE 9

| | | | Comparative | Comparative | Comparative | Comparative |
|---|---|---|---|---|---|---|
| | | | Example 1 | Example 2 | Example 3 | Example 4 |
| Charge | Cellulose | Kind | CA7-3 | CA7-3 | CA7-3 | CA7-3 |
| Composition | Acylate (A) | Parts by | 100 | 100 | 100 | 100 |
| Ratio | | Mass | | | | |
| | Polyether | Product | — | — | — | — |
| | Derivative | Name | | | | |
| | (B) | (Kind) | | | | |
| | | Parts by | — | — | — | — |
| | | Mass | | | | |
| | | Product | — | — | — | — |
| | | Name | | | | |
| | | (Kind) | | | | |
| | | Parts by | — | — | — | — |
| | | Mass | | | | |
| | Other | Kind | PEG | RS1000 | Daifatty | — |
| | Additives | | | | 101 | |
| | | Parts by | 15 | 15 | 15 | — |
| | | Mass | | | | |
| Kneading | Cylinder | ° C. | 220 | 220 | 230 | 250 |
| | Temperature | | | | | |
| Molding | Cylinder | ° C. | 220 | 220 | 230 | 270 |
| | Temperature | | | | | |
| | Mold | ° C. | 60 | 60 | 60 | 60 |
| | Temperature | | | | | |
| Continuous Moldability | | | C | C | C | C |
| Screw Noise | | | B | C | C | C |
| Melt Viscosity | | Pa · s | 378 | 787 | 824 | Unmeasurable |
| (220° C., 1216 s⁻¹) | | | | | | |
| Melt Viscosity | | Pa · s | — | — | — | — |
| (200° C., 1216 s⁻¹) | | | | | | |
| Mechanical | Tensile | MPa | 68 | 63 | 70 | 75 |
| Strength | Stress | | | | | |
| | Tensile | % | 10.5 | 13.2 | 9.2 | 4.8 |
| | Elongation | | | | | |
| | at Break | | | | | |
| | Charpy | KJ/m² | 9.7 | 12.8 | 4.4 | 2.8 |
| | Impact | | | | | |
| | Strength | | | | | |

| | | | | | |
|---|---|---|---|---|---|
| Degree of Brown Coloring | — | 200 | 250 | 220 | >1000 |
| (APHA Method) | | | | | |
| Transparency Degree | % | 80 | 89 | 87 | 0 |
| (Total Light Transmittance) | | | | | |

| | | | | |
|---|---|---|---|---|
| Bleeding Property | 1 | 2 | 2 | 5 |

### Examples 17 to 22 and Comparative Examples 5 to 7

Examples 17 to 22 obtained by changing the content of the polyether derivative (B) (PE6) in Example 1 and Comparative Examples 5 to 7 obtained by replacing the polyether derivative (B) with the same amount of plasticizer A (Daifatty 101) in Examples 19 to 21 will be shown.

Production of Resin Composition (pellets) and Test Piece

Specifically, a resin composition (pellets) is obtained using a twin-screw kneader (manufactured by TOSHIBA MACHINE CO., LTD, TEX41SS) at a charge composition ratio and a temperature shown in Table 10.

A dumbbell and a test piece D2 are obtained in the same manner as in Example 1.

TABLE 10

| | | | | | | Compar- | | Compar- | | Compar- | |
|---|---|---|---|---|---|---|---|---|---|---|---|
| | | | | | | ative | | ative | | ative | |
| | | | Exam- | Exam- | Exam- | Exam- | Exam- | Exam- | Exam- | Exam- | Exam- |
| | | | ple 17 | ple 18 | ple 19 | ple 5 | ple 20 | ple 6 | ple 21 | ple 7 | ple 22 |
| Charge | Cellulose | Kind | CA7-3 | CA7-3 | CA7-3 | CA7-3 | CA7-3 | CA7-3 | CA7-3 | CA7-3 | CA7-3 |
| Composition | Acylate (A) | Parts by | 100 | 100 | 100 | 100 | 100 | 100 | 100 | 100 | 100 |
| Ratio | | Mass | | | | | | | | | |
| | Polyether | Product | PKA-5008 | PKA-5008 | PKA-5008 | — | PKA-5008 | — | PKA-5008 | — | PKA-5008 |
| | Derivative | Name | (PE6) | (PE6) | (PE6) | | (PE6) | | (PE6) | | (PE6) |
| | (B) | (Kind) | | | | | | | | | |
| | | Parts by | 1 | 5 | 10 | — | 20 | — | 25 | — | 30 |
| | | Mass | | | | | | | | | |
| | | Product | — | — | — | — | — | — | — | — | — |
| | | Name | | | | | | | | | |
| | | (Kind) | | | | | | | | | |
| | | Parts by | — | — | — | — | — | — | — | — | — |
| | | Mass | | | | | | | | | |
| | Other | Kind | — | — | — | Daifatty | — | Daifatty | — | Daifatty | — |
| | Additives | | | | | 101 | | 101 | | 101 | |
| | | Parts by | — | — | — | 10 | — | 20 | — | 25 | — |
| | | Mass | | | | | | | | | |
| Kneading | Cylinder | ° C. | 230 | 230 | 220 | 240 | 210 | 220 | 210 | 220 | 210 |
| | Temperature | | | | | | | | | | |
| Molding | Cylinder | ° C. | 240 | 230 | 220 | 240 | 220 | 220 | 210 | 220 | 210 |
| | Temperature | | | | | | | | | | |
| | Mold | ° C. | 60 | 60 | 60 | 60 | 60 | 60 | 60 | 60 | 60 |
| | Temperature | | | | | | | | | | |
| Melt Viscosity | | Pa · s | 1243 | 871 | 663 | Unmeasurable | 120 | 531 | 58 | 398 | 22 |
| (220° C., 1216 s⁻¹) | | | | | | | | | | | |
| Melt Viscosity | | Pa · s | — | — | — | — | — | — | — | — | — |
| (200° C., 1216 s⁻¹) | | | | | | | | | | | |
| Mechanical | Tensile | MPa | 76 | 72 | 69 | 78 | 65 | 62 | 63 | 58 | 60 |
| Strength | Stress | | | | | | | | | | |
| | Tensile | % | 8 | 9.6 | 11.2 | 8.1 | 18.4 | 12.2 | 20.8 | 14.3 | 22.5 |
| | Elongation | | | | | | | | | | |
| | at Break | | | | | | | | | | |
| | Charpy | KJ/m² | 7 | 8.4 | 10.2 | 3.2 | 15.8 | 7.2 | 17.9 | 11.5 | 19 |
| | Impact | | | | | | | | | | |
| | Strength | | | | | | | | | | |

| | | | | | | | | | | |
|---|---|---|---|---|---|---|---|---|---|---|
| Degree of Brown Coloring | — | 110 | 120 | 130 | 210 | 130 | 210 | 130 | 200 | 130 |
| (APHA Method) | | | | | | | | | | |
| Transparency Degree | % | 95 | 95 | 95 | 84 | 95 | 90 | 95 | 91 | 95 |
| (Total Light Transmittance) | | | | | | | | | | |

| | | | | | | | | | |
|---|---|---|---|---|---|---|---|---|---|
| Bleeding Property | 5 | 5 | 5 | 3 | 5 | 2 | 4 | 1 | 4 |

As can be seen from the comparison between Example 19 and Comparative Example 5, the comparison between Example 20 and Comparative Example 6, and the comparison between Example 21 and Comparative Example 7, the melt viscosity can be further reduced by adding the polyether derivative (B) to the cellulose acylate (A) than in a case where the same amount of plasticizer A (Daifatty 101) is added.

### Examples 23 and 24 and Comparative Examples 8 and 9

Examples 23 and 24 obtained by replacing the cellulose acetate CA7-3 with the cellulose acetate CA7-1 or CA7-2 in Example 1 and Comparative Examples 8 and 9 obtained by replacing the polyether derivative (B) with the same amount of plasticizer A (Daifatty 101) in Examples 23 and 24 will be shown.

Production of Resin Composition (pellets) and Test Piece

Specifically, a resin composition (pellets) is obtained using a twin-screw kneader (manufactured by TOSHIBA MACHINE CO., LTD, TEX41SS) at a charge composition ratio and a temperature shown in Table 11.

A dumbbell and a test piece D2 are obtained in the same manner as in Example 1.

TABLE 11

| | | | | Comparative | | Comparative |
|---|---|---|---|---|---|---|
| | | | Example 23 | Example 8 | Example 24 | Example 9 |
| Charge | Cellulose | Kind | CA7-1 | CA7-1 | CA7-2 | CA7-2 |
| Composition | Acylate (A) | Parts by | 100 | 100 | 100 | 100 |
| Ratio | | Mass | | | | |
| | Polyether | Product | PKA-5008 | — | PKA-5008 | — |
| | Derivative | Name | (PE6) | | (PE6) | |
| | (B) | (Kind) | | | | |
| | | Parts by | 15 | — | 15 | — |
| | | Mass | | | | |
| | | Product | — | — | — | — |
| | | Name | | | | |
| | | (Kind) | | | | |
| | | Parts by | — | — | — | — |
| | | Mass | | | | |
| | Other | Kind | — | Daifatty | — | Daifatty |
| | Additives | | | 101 | | 101 |
| | | Parts by | — | 15 | — | 15 |
| | | Mass | | | | |
| Kneading | Cylinder | ° C. | 220 | 240 | 220 | 240 |
| | Temperature | | | | | |
| Molding | Cylinder | ° C. | 220 | 240 | 220 | 240 |
| | Temperature | | | | | |
| | Mold | ° C. | 60 | 60 | 60 | 60 |
| | Temperature | | | | | |
| Melt Viscosity | | Pa · s | 549 | Unmeasurable | 412 | Unmeasurable |
| (220° C., 1216 s⁻¹) | | | | | | |
| Melt Viscosity | | Pa · s | — | — | — | — |
| (200° C., 1216 s⁻¹) | | | | | | |
| Melt Viscosity | | Pa · s | — | 1274 | — | 673 |
| (230° C., 1216 s⁻¹) | | | | | | |
| Mechanical | Tensile | MPa | 69 | 69 | 68 | 68 |
| Strength | Stress | | | | | |
| | Tensile | % | 14.8 | 14.6 | 13.5 | 13.8 |
| | Elongation | | | | | |
| | at Break | | | | | |
| | Charpy | KJ/m² | 14.1 | 13.9 | 13.2 | 13.6 |
| | Impact | | | | | |
| | Strength | | | | | |

| | | | | | |
|---|---|---|---|---|---|
| Degree of Brown Coloring | — | 130 | 130 | 130 | 130 |
| (APHA Method) | | | | | |
| Transparency Degree | % | 94 | 94 | 94 | 94 |
| (Total Light Transmittance) | | | | | |

| | | | | |
|---|---|---|---|---|
| Bleeding Property | 5 | 2 | 5 | 2 |

As can be seen from the comparison between Example 23 and Comparative Example 8 and the comparison between Example 24 and Comparative Example 9, the melt viscosity can be further reduced by adding the polyether derivative (B) to the cellulose acylate (A) than in a case where the same amount of plasticizer A (Daifatty 101) is added.

### Examples 25 to 32

Examples 25 to 32 obtained by replacing the cellulose acetate CA7-3 with the cellulose acetates CA1 to CA6, CA8, and CA9 in Example 1 will be shown.

Production of Resin Composition (pellets) and Test Piece

Specifically, a resin composition (pellets) is obtained using a twin-screw kneader (manufactured by TOSHIBA MACHINE CO., LTD, TEX41SS) at a charge composition ratio and a temperature shown in Table 12.

A dumbbell and a test piece D2 are obtained in the same manner as in Example 1.

TABLE 12

| | | | Exam- | Exam- | Exam- | Exam- | Exam- | Exam- | Exam- | Exam- |
|---|---|---|---|---|---|---|---|---|---|---|
| | | | ple 25 | ple 26 | ple 27 | ple 28 | ple 29 | ple 30 | ple 31 | ple 32 |
| Charge | Cellulose | Kind | CA1 | CA2 | CA3 | CA4 | CA5 | CA6 | CA8 | CA9 |
| Composition | Acylate (A) | Parts by | 100 | 100 | 100 | 100 | 100 | 100 | 100 | 100 |
| Ratio | | Mass | | | | | | | | |
| | Polyether | Product | PKA-5008 | PKA-5008 | PKA-5008 | PKA-5008 | PKA-5008 | PKA-5008 | PKA-5008 | PKA-5008 |
| | Derivative | Name | (PE6) | (PE6) | (PE6) | (PE6) | (PE6) | (PE6) | (PE6) | (PE6) |
| | (B) | (Kind) | | | | | | | | |
| | | Parts by | 15 | 15 | 15 | 15 | 15 | 15 | 15 | 15 |
| | | Mass | | | | | | | | |
| | | Product | — | — | — | — | — | — | — | — |
| | | Name | | | | | | | | |
| | | (Kind) | | | | | | | | |
| | | Parts by | — | — | — | — | — | — | — | — |
| | | Mass | | | | | | | | |
| | Other | Kind | — | — | — | — | — | — | — | — |
| | Additives | Parts by | — | — | — | — | — | — | — | — |
| | | Mass | | | | | | | | |
| Kneading | Cylinder | ° C. | 220 | 220 | 220 | 220 | 220 | 220 | 220 | 220 |
| | Temperature | | | | | | | | | |
| Molding | Cylinder | ° C. | 220 | 220 | 220 | 220 | 220 | 220 | 220 | 220 |
| | Temperature | | | | | | | | | |
| | Mold | ° C. | 60 | 60 | 60 | 60 | 60 | 60 | 60 | 60 |
| | Temperature | | | | | | | | | |
| Continuous Moldability | | | A | A | A | A | A | A | A | A |
| Screw Noise | | | A | A | A | A | A | A | A | A |
| Melt Viscosity | | Pa · s | 243 | 197 | 297 | 189 | 301 | 227 | 359 | 178 |
| (220° C., 1216 s⁻¹) | | | | | | | | | | |
| Melt Viscosity | | Pa · s | — | — | — | — | — | — | — | — |
| (200° C., 1216 s⁻¹) | | | | | | | | | | |
| Mechanical | Tensile | MPa | 67 | 66 | 67 | 66 | 67 | 67 | 69 | 67 |
| Strength | Stress | | | | | | | | | |
| | Tensile | % | 14.6 | 14.7 | 13.8 | 14.7 | 14.2 | 14.6 | 13.9 | 14.2 |
| | Elongation | | | | | | | | | |
| | at Break | | | | | | | | | |
| | Charpy | KJ/m² | 13.8 | 12.2 | 12.4 | 13.5 | 14.2 | 13.6 | 12.5 | 13.7 |
| | Impact | | | | | | | | | |
| | Strength | | | | | | | | | |

| | | | | | | | | | |
|---|---|---|---|---|---|---|---|---|---|
| Degree of Brown Coloring | — | 130 | 130 | 130 | 130 | 130 | 130 | 130 | 120 |
| (APHA Method) | | | | | | | | | |
| Transparency Degree | % | 93 | 95 | 94 | 94 | 93 | 95 | 94 | 94 |
| (Total Light Transmittance) | | | | | | | | | |

| | | | | | | | | |
|---|---|---|---|---|---|---|---|---|
| Bleeding Property | 5 | 5 | 5 | 5 | 5 | 5 | 5 | 5 |

### Examples 33 to 38

Examples 33 to 35 obtained by using two kinds of polyether derivatives (B) in combination and Examples 36 to 38 obtained by using the polyether derivative (B) and various plasticizers in combination will be shown.

Production of Resin Composition (pellets) and Test Piece

Specifically, a resin composition (pellets) is obtained using a twin-screw kneader (manufactured by TOSHIBA MACHINE CO., LTD, TEX41SS) at a charge composition ratio and a temperature shown in Table 13.

A dumbbell and a test piece D2 are obtained in the same manner as in Example 1.

TABLE 13

| | | | Example 33 | Example 34 | Example 35 | Example 36 | Example 37 | Example 38 |
|---|---|---|---|---|---|---|---|---|
| Charge | Cellulose | Kind | CA7-3 | CA7-3 | CA7-3 | CA7-3 | CA7-3 | CA7-3 |
| Composition | Acylate (A) | Parts by | 100 | 100 | 100 | 100 | 100 | 100 |
| Ratio | | Mass | | | | | | |
| | Polyether | Product | PKA-5008 | PKA-5008 | PKA-5008 | PKA-5008 | PKA-5008 | PKA-5008 |
| | Derivative | Name | (PE6) | (PE6) | (PE6) | (PE6) | (PE6) | (PE6) |
| | (B) | (Kind) | | | | | | |
| | | Parts by | 10 | 10 | 10 | 10 | 5 | 15 |
| | | Mass | | | | | | |
| | | Product | AA-480R | AA-800 | PKA-5003 | — | — | — |
| | | Name | (PE9) | (PE10) | (PE5) | | | |
| | | (Kind) | | | | | | |
| | | Parts by | 5 | 5 | 10 | — | — | — |
| | | Mass | | | | | | |
| | Other | Kind | — | — | — | Daifatty | Daifatty | Daifatty |
| | Additives | | | | | 101 | 101 | 101 |
| | | Parts by | — | — | — | 5 | 15 | 5 |
| | | Mass | | | | | | |
| Kneading | Cylinder | ° C. | 220 | 220 | 220 | 220 | 220 | 220 |
| | Temperature | | | | | | | |
| Molding | Cylinder | ° C. | 220 | 220 | 220 | 220 | 220 | 220 |
| | Temperature | | | | | | | |
| | Mold | ° C. | 60 | 60 | 60 | 60 | 60 | 60 |
| | Temperature | | | | | | | |
| Continuous Moldability | | | A | A | A | A | A | A |
| Screw Noise | | | A | A | A | B | B | A |
| Melt Viscosity | | Pa · s | 164 | 179 | 129 | 226 | 247 | 217 |
| (220° C., 1216 s⁻¹) | | | | | | | | |
| Melt Viscosity | | Pa · s | — | — | — | — | — | — |
| (200° C., 1216 s⁻¹) | | | | | | | | |
| Mechanical | Tensile | MPa | 63 | 64 | 63 | 63 | 61 | 63 |
| Strength | Stress | | | | | | | |
| | Tensile | % | 19.7 | 18.1 | 18.5 | 14.5 | 13.4 | 15.1 |
| | Elongation | | | | | | | |
| | at Break | | | | | | | |
| | Charpy | KJ/m² | 12.4 | 17.9 | 18.7 | 10.2 | 8.5 | 11.5 |
| | Impact | | | | | | | |
| | Strength | | | | | | | |

| | | | | | | | |
|---|---|---|---|---|---|---|---|
| Degree of Brown Coloring | — | 130 | 130 | 140 | 130 | 170 | 120 |
| (APHA Method) | | | | | | | |
| Transparency Degree | % | 93 | 95 | 95 | 94 | 92 | 93 |
| (Total Light Transmittance) | | | | | | | |

| | | | | | | |
|---|---|---|---|---|---|---|
| Bleeding Property | 5 | 5 | 5 | 5 | 4 | 5 |

### Examples 39 to 47

Examples 39 to 46 obtained by adding various polyether derivatives (B) to the cellulose acetate propionate CAP and Example 47 obtained by adding the polyether derivative (B) (PE17) to the cellulose acetate CA7-3 will be shown.

Production of Resin Composition (pellets) and Test Piece

Specifically, a resin composition (pellets) is obtained using a twin-screw kneader (manufactured by TOSHIBA MACHINE CO., LTD, TEX41SS) at a charge composition ratio and a temperature shown in Table 14.

A dumbbell and a test piece D2 are obtained in the same manner as in Example 1.

TABLE 14

| | | | Exam- | Exam- | Exam- | Exam- | Exam- | Exam- | Exam- | Exam- | Exam- |
|---|---|---|---|---|---|---|---|---|---|---|---|
| | | | ple 39 | ple 40 | ple 41 | ple 42 | ple 43 | ple 44 | ple 45 | ple 46 | ple 47 |
| Charge | Cellulose | Kind | CAP | CAP | CAP | CAP | CAP | CAP | CAP | CAP | CA7-3 |
| Composition | Acylate (A) | Parts by | 100 | 100 | 100 | 100 | 100 | 100 | 100 | 100 | 100 |
| Ratio | | Mass | | | | | | | | | |
| | Polyether | Product | PKA-5003 | PKA-5008 | AE-400 | AP-400 | PKA-5008 | PKA-5008 | AP-400 | AP-400 | PKA-5018 |
| | Derivative | Name | (PE5) | (PE6) | (PE12) | (PE13) | (PE6) | (PE6) | (PE13) | (PE13) | (PE17) |
| | (B) | (Kind) | | | | | | | | | |
| | | Parts by | 12.5 | 12.5 | 12.5 | 12.5 | 10 | 5 | 10 | 5 | 15 |
| | | Mass | | | | | | | | | |
| | | Product | — | — | — | — | — | — | — | — | — |
| | | Name | | | | | | | | | |
| | | (Kind) | | | | | | | | | |
| | | Parts by | — | — | — | — | — | — | — | — | — |
| | | Mass | | | | | | | | | |
| | Other | Kind | — | — | — | — | — | — | — | — | — |
| | Additives | Parts by | — | — | — | — | — | — | — | — | — |
| | | Mass | | | | | | | | | |
| Kneading | Cylinder | ° C. | 200 | 200 | 200 | 200 | 200 | 200 | 200 | 200 | 220 |
| | Temperature | | | | | | | | | | |
| Molding | Cylinder | ° C. | 200 | 200 | 200 | 200 | 200 | 200 | 200 | 200 | 220 |
| | Temperature | | | | | | | | | | |
| | Mold | ° C. | 60 | 60 | 60 | 60 | 60 | 60 | 60 | 60 | 60 |
| | Temperature | | | | | | | | | | |
| Melt Viscosity | | Pa · s | — | — | — | — | — | — | — | — | 420 |
| (220° C., 1216 s⁻¹) | | | | | | | | | | | |
| Melt Viscosity | | Pa · s | 137 | 147 | 135 | 170 | 354 | 694 | 406 | 763 | — |
| (200° C., 1216 s⁻¹) | | | | | | | | | | | |
| Mechanical | Tensile | MPa | 43 | 41 | 43 | 45 | 61 | 70 | 65 | 72 | 71 |
| Strength | Stress | | | | | | | | | | |
| | Tensile | % | 32.6 | 34.5 | 23.3 | 26.5 | 25.6 | 17.6 | 17.9 | 12.7 | 13.3 |
| | Elongation | | | | | | | | | | |
| | at Break | | | | | | | | | | |
| | Charpy | KJ/m² | 21.9 | 20.7 | 19.4 | 18.6 | 14.2 | 11.7 | 13.2 | 10.9 | 11.6 |
| | Impact | | | | | | | | | | |
| | Strength | | | | | | | | | | |

| | | | | | | | | | | |
|---|---|---|---|---|---|---|---|---|---|---|
| Degree of Brown Coloring | — | 110 | 100 | 100 | 100 | 100 | 100 | 100 | 100 | 120 |
| (APHA Method) | | | | | | | | | | |
| Transparency Degree | % | 96 | 95 | 93 | 96 | 93 | 92 | 94 | 94 | 93 |
| (Total Light Transmittance) | | | | | | | | | | |

| | | | | | | | | | |
|---|---|---|---|---|---|---|---|---|---|
| Bleeding Property | 4 | 5 | 5 | 5 | 5 | 5 | 5 | 5 | 5 |

Evaluation

Continuous Moldability

The continuous moldability is evaluated in accordance with the following standards.

The results are shown in Tables 7 to 14.

Evaluation Standards

A: It is possible to continuously mold test pieces D2 (50 shots continuously), and defects such as cracks do not occur in the test pieces D2.

B: It is not possible to continuously mold test pieces D2 by 50 shots, but the molding is possible by manually adding pellets bit by bit

C: Plasticization defects occur and molding is impossible.

Screw Noise

The screw noise during the molding is evaluated in accordance with the following standards.

Evaluation Standards

A: No abnormal noise is generated from the screw during the molding.

B: In some cases, abnormal noise is generated from the screw during the molding.

C: Abnormal noise is always generated from the screw during the molding.

Melt Viscosity

The melt viscosity (Pa·s) of the obtained pellets is measured by a method based on JIS K7199 (1999) with the use of CAPILOGRAPH 1C (manufactured by TOYO SEIKI SEISAKU-SHO, LTD.) under conditions of a temperature of 200° C. and a shear rate of 1216/s, conditions of a temperature of 220° C. and a shear rate of 1216/s, or conditions of a temperature of 230° C. and a shear rate of 1216/s.

The results are shown in Tables 7 to 14. In the tables, “-” in the melt viscosity field represents that the measurement is not performed.

Mechanical Strength

Tensile Stress and Tensile Elongation at Break

The measurement of tensile stress and tensile elongation at break is performed on the obtained dumbbell test piece by a method based on ISO527 with the use of a universal testing device (manufactured by SHIMADZU CORPORATION, AUTOGRAPH AG-X plus).

The results are shown in Tables 7 to 14.

Charpy Impact Strength

The obtained dumbbell test piece is processed into a notched impact test piece by a method based on ISO179, and subjected to the measurement of a notched impact strength at 23° C. with an impact strength measurement device (manufactured by TOYO SEIKI SEISAKU-SHO, LTD., CHARPY AUTO-IMPACT TESTER CHN3). The result is evaluated as a Charpy impact strength.

The results are shown in Tables 7 to 14.

Transparency

Degree of Brown Coloring

The Hazen color number (APHA) of the obtained test piece D2 is measured using a spectroscopic colorimeter/color-difference meter (NIPPON DENSHOKU INDUSTRIES Co., LTD., TZ6000), and evaluated as a degree of brown coloring.

The results are shown in Tables 7 to 14.

Transparency Degree

The total light transmittance of the obtained test piece D2 is measured by a method based on JIS K7375 with the use of a haze/transmittance meter (MURAKAMI COLOR RESEARCH LABORATORY, MH-150), and evaluated as a transparency degree.

The results are shown in Tables 7 to 14.

Bleeding Property

A letter is written on the test piece D2 by a marker (manufactured by ZEBRA CO., LTD., MACKEE), and the test piece is put into a thermohygrostat bath with a humidity of 95% at 65° C. for 1,000 hours. Then, surface stickiness of the test piece D2, deformation of the test piece D2, and the presence or absence of marker bleeding are confirmed and evaluated in accordance with the following standards.

Evaluation Standards

5: The test piece D2 has no surface stickiness or deformation. There is no marker bleeding in a case where the test piece is observed by a microscope.

4: The test piece D2 has no surface stickiness or deformation. Although not visually recognized, the marker bleeds in a case where the test piece is observed by a microscope.

3: The test piece D2 has no surface stickiness or deformation, but the marker bleeds.

2: The surface of the test piece D2 is visually sticky. Deformation does not occur, but the marker bleeds.

1: The test piece D2 is deformed. Moreover, the marker bleeds to such an extent that the letter cannot be read.

From the above results, it is found that the melt viscosity of the resin composition (pellets) is lower in the examples than in the comparative examples. That is, it is found that the fluidity is more excellent in the examples than in the comparative examples.

In addition, it is found that a resin molded article in which bleeding is more suppressed is obtained in the examples than in Comparative Examples 1 to 3 and 5 to 9.

In addition, it is found that the examples have good results in the evaluation of continuous moldability and screw noise during the molding.

Moreover, it is found that an obtained resin molded article ensures a mechanical strength and excellent transparency is obtained in the examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose acylate (A); and
a polyether derivative (B) having at least one carbon-carbon unsaturated bond excluding an aromatic group in a molecule.

2. The resin composition according to claim 1,
wherein the polyether derivative (B) is a compound represented by Formula (X), 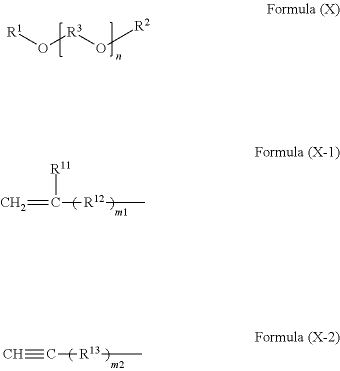
in Formula (X), R¹ represents a group represented by Formula (X-1) or a group represented by Formula (X-2), R² represents a group represented by Formula (X-1), a group represented by Formula (X-2), a hydrogen atom, an alkyl group having 1 to 10 carbon atoms, a phenyl group, or a benzyl group, R³ represents an alkylene group having 1 to 5 carbon atoms, and n represents an integer of 1 to 50,
in Formula (X-1), R¹¹ represents a hydrogen atom or a methyl group, R¹² represents —CH₂— or —CO—, and m1 represents 0 or 1, and
in Formula (X-2), R¹³ represents —CH₂— or —CO—, and m2 represents 0 or 1.

3. The resin composition according to claim 2,
wherein in Formula (X), R¹ represents the group represented by Formula (X-1).

4. The resin composition according to claim 3,
wherein in Formula (X-1), R¹² represents —CH₂—.

5. The resin composition according to claim 1,
wherein a substitution degree of the cellulose acylate (A) is 2.0 or greater and 2.9 or less.

6. The resin composition according to claim 1,
wherein a ratio of the cellulose acylate (A) to the entire resin composition is 50 mass % or greater and 99 mass % or less.

7. The resin composition according to claim 1,
wherein the content of the polyether derivative (B) with respect to 100 parts by mass of the cellulose acylate (A) is 1.0 part by mass or greater and 30 parts by mass or less.

8. The resin composition according to claim 1,
wherein a weight average molecular weight of the polyether derivative (B) is 200 or greater and 3,000 or less.

9. The resin composition according to claim 1,
wherein Hansen's solubility parameter (SP value) of the polyether derivative (B) is 17 (cal/cm³)^{1/2} or greater and 21 (cal/cm³)^{1/2} or less.

10. A resin molded article that is obtained by molding the resin composition according to claim 1.
